(19) United States
(12) Patent Application Publication
(10) Pub. No.: US 2019/0065559 A1
(43) Pub. Date: Feb. 28, 2019

(54) COMPUTER SYSTEM AND DATABASE MANAGEMENT METHOD

(71) Applicant: HITACHI, LTD., Tokyo (JP)

(72) Inventor: Satoru Watanabe, Tokyo (JP)

(73) Assignee: HITACHI, LTD., Tokyo (JP)

(21) Appl. No.: 16/080,113

(22) PCT Filed: Jun. 28, 2016
(86) PCT No.: PCT/JP2016/069094

§ 371 Date: Aug. 27, 2018

(51) Int. Cl. G06F 17/30

(52) U.S. Cl. CPC G06F 17/30545; G06F 17/30519; G06F 17/3048; G06F 17/30498; G06F 17/3033

(57) ABSTRACT

A processor unit executed first processing among join processing that includes the first processing and second processing sequentially executed in response to a query. The processor unit transmits one or more commands for execution of a part of processing of the second processing among the join processing to one or more accelerators configured to read data from one or more storage media storing a database including a plurality of database tables and receive execution results of local processing from the respective one or more accelerators. The local processing is accordance with the received command among the part of processing in the respective one or more accelerators. The processor unit executed remaining processing of the second processing based on execution results from the respective one or more accelerators and return a result of the query based on an execution result of the remaining processing.

### TECHNICAL FIELD

The present invention generally relates to a data management technology.

### BACKGROUND ART

As database processing, there has been known join processing that merges data of a plurality of tables to create a new table. There has been generally known hash join processing as one example of the join processing. A technology that executes the hash join processing by load sharing (parallel execution) with a plurality of calculators (processing modules) has been known (Patent Literature 1).

### CITATION LIST

### Patent Literature

Patent Literature 1: U.S. Pat. No. 8,195,644

### SUMMARY OF INVENTION

### Technical Problem

Recently, to improve performance of a computing system, a technology that utilizes, for example, an FPGA (Field-Programmable Gate Array) and a GPU (Graphic Processor Unit) as an accelerator in addition to a CPU (Central Processing Unit) has been developed.

High-speed database processing by offloading a part of database processing on such accelerators is considered.

There has been known the hash join processing as the database processing as described above.

However, the high-speed hash join processing cannot be achieved by replacing at least one of a plurality of calculators disclosed in Patent Literature 1 with the accelerator. This is because, while the hash join processing generally includes build processing and probe processing, all of the plurality of calculators need to execute the build processing and the probe processing in Patent Literature 1. In other words, this is because a sufficient amount of resource enough to execute the build processing and the probe processing is demanded to each calculator. Specifically, for example, while holding a hash table (a build table) is required to execute the build processing, a comparatively large amount of resource is required to store the hash table and execute aggregation processing using the hash table.

Meanwhile, the amount of resource of the accelerator is generally smaller than the amount of resource required for the calculator that can execute both the build processing and the probe processing.

### Solution to Problem

A processor unit is configured to execute first processing among join processing that includes the first processing and second processing sequentially executed in response to a query. The processor unit is configured to transmit one or more commands for execution of a part of processing of the second processing among the join processing to one or more accelerators configured to read data from one or more storage media storing a database including a plurality of DB tables (database tables) and receive execution results of local processing from the respective one or more accelerators. The local processing is processing in accordance with the received command among the part of processing in the respective one or more accelerators. The processor unit is configured to execute remaining processing of the second processing based on execution results from the respective one or more accelerators and return a result of the query based on an execution result of the remaining processing.

### Advantageous Effects of Invention

Join processing using an accelerator can be achieved, and the high-speed join processing becomes possible.

### BRIEF DESCRIPTION OF DRAWINGS

FIG. 1 illustrates a configuration of a computer system according to a first embodiment.

FIG. 2 illustrates a configuration of a DB management table.

FIG. 3 illustrates a configuration of a segment management table.

FIG. 4 illustrates one example of a query.

FIG. 5 is a schematic diagram of an outline of join processing according to the first embodiment.

FIG. 6 illustrates a process flowchart by a query executing unit.

FIG. 7 illustrates one example of a local command.

FIG. 8 illustrates a process flowchart by a control unit.

FIG. 9 illustrates one example of aggregation results.

FIG. 10 illustrates a configuration of a computer system according to a second embodiment.

FIG. 11 illustrates a configuration of a computer system according to a third embodiment.

### DESCRIPTION OF EMBODIMENTS

The following describes some embodiments of the present invention with reference to the drawings. Note that these embodiments are merely one example for achieving the present invention and do not limit the technical scope of the present invention.

In the following description, “interface unit” includes one or more interfaces. The one or more interfaces may be one or more interface devices (for example, one or more NIC (Network Interface Cards)) of an identical type or may be two or more interface devices (for example, the NIC and an HBA (Host Bus Adapter)) of different types.

In the following description, “storage resource” includes one or more memories. At least one memory may be a volatile memory or may be a non-volatile memory. The storage resource may include one or more PDEVs in addition to the one or more memories. The “PDEV” means a physical storage device and typically may be a non-volatile storage device (for example, an auxiliary storage device). The PDEV may be, for example, an HDD (Hard Disk Drive) or an SSD (Solid State Drive).

In the following description, “processor unit” includes one or more processors. At least one processor is typically a Central Processing Unit (CPU). The processor may include a hardware circuit executing a part of or all processes.

While the following description describes a processing unit (a function) by an expression of “kkk unit” in some cases, the processing unit may be achieved by execution of a computer program by the processor unit or may be achieved by a hardware circuit (for example, the FPGA or an ASIC (Application Specific Integrated Circuit)). When the processing unit is achieved by the execution of the program by the processor unit, since determined processing is executed while, for example, the storage resource (for example, the memory) and/or a communication interface device (for example, a communication port) is appropriately used, the processing unit may be configured as at least apart of the processor unit. Processing described with the processing unit as a subject may be processing executed by the processor unit or a device that includes the processor unit. The processor unit may include a hardware circuit executing a part of or all processing. The program may be installed from a program source to the processor. The program source may be, for example, a recording medium (for example, a non-transitory recording medium) readable by a program distribution calculator or a calculator. The descriptions of the respective processing units are one example. A plurality of processing units may be integrated into one processing unit, or one processing unit may be divided into a plurality of processing units.

While the following description describes information by an expression such as “xxx management table” in some cases, the information may be expressed by any data structure. That is, for an indication that the information is independent of the data structure, “xxx management table” can also be referred to as “xxx management information.” In the following description, configurations of respective tables are one example. One table may be divided into two or more tables, or all or some of two or more tables may be integrated into one table.

The following description abbreviates “database” as “DB.” Tables as the DB are referred to as “DB tables.”

In the following description, “computer system” is a system that includes at least one calculator. In view of this, “computer system” may be one calculator, may be a plurality of calculators, or may include a device other than the calculator in addition to the calculator. Additionally, “calculator” may be one or more physical calculators and may include at least one virtual calculator.

In the following description, “aggregation processing” means processing that aggregates a plurality of values (data) into one value. The following description employs total processing as one example of the aggregation processing. However, another aggregation processing such as processing that calculates an average value may be employed as the aggregation processing.

The following description employs hash join processing as one example of “join processing.” However, join processing other than the hash join processing may be employed as the join processing.

Since the following description employs the hash join processing as the join processing, the plurality of DB tables included in the database include one or more star schemas. The star schema includes one Fact table and one or more Dimension tables associated with the Fact table.

In the following description, when the description is given without distinction of identical kinds of elements, the common part of reference numeral is used. When the description is given with distinction of identical kinds of elements, reference numeral is used in some cases.

### First Embodiment

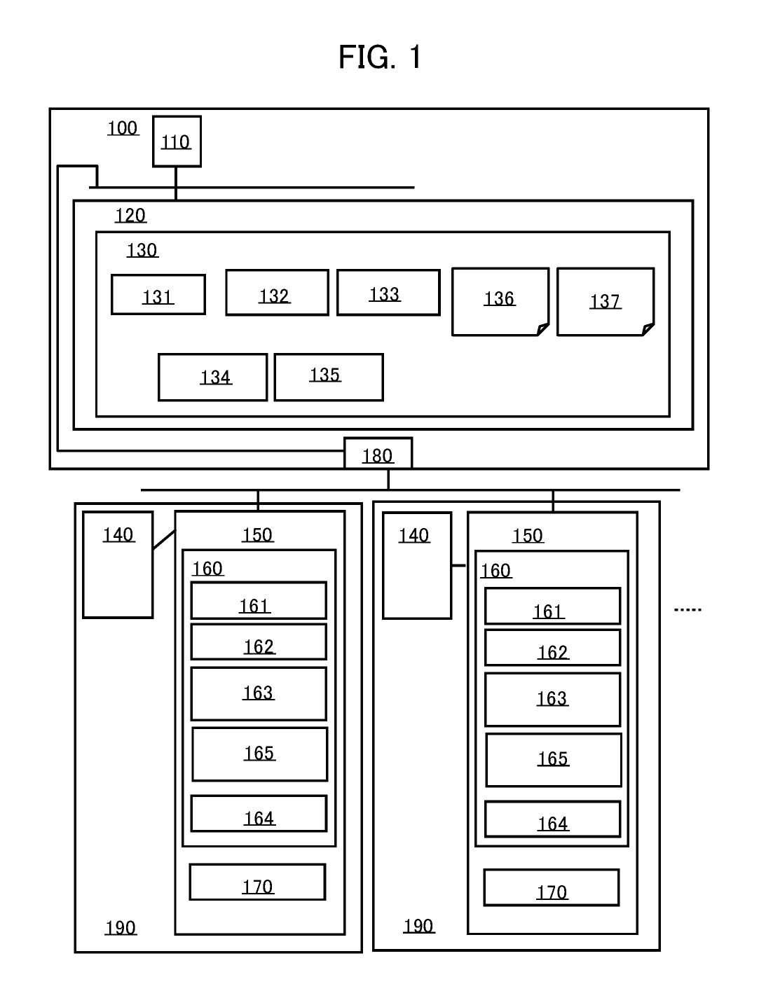

FIG. 1 illustrates a configuration example of a computer system according to the first embodiment.

A plurality of (or one) SSDs 140 (Solid State Drives), a plurality of (or one) DB processing boards 150, and a server 100 are provided. This embodiment includes a plurality of (or one) storage packages 198. The plurality of storage packages 198 each include the at least one SSD 140 and the at least one DB processing board 150 that reads data from the at least one SSD 140. In this embodiment, the SSDs 140 correspond to the DB processing boards 150 on a one-to-one basis. The SSDs 140 and the DB processing boards 150 corresponding to one another are disposed in the storage packages 198. A data read source for the DB processing board 150 is the SSD 140 in the storage package 198 in which the DB processing board 150 is present and is not the SSD 140 in the storage package 198 different from the storage package 198 in which the DB processing board 150 is present. However, the present invention is not limited to this. For example, the correspondence relationship between the SSDs 140 and the DB processing boards 150 needs not to be on a one-to-one basis, or the storage package 198 may be eliminated (for example, the one DB processing board 150 may correspond to the plurality of SSDs 140).

Each of the SSDs 140 is one example of a storage medium (for example, a non-volatile storage medium). Each of the DB processing boards 150 is one example of the hardware circuit. The hardware circuit is one example of the accelerator. That is, the DB processing board 150 is one example of the accelerator. The DB processing boards 150 each include a FPGA 160 including an SRAM (Static Random Access Memory) 164 and a DRAM (Dynamic Random Access Memory) 170. The SRAM 164 is one example of an internal memory. The internal memory is one example of a first memory. The DRAM 170 is one example of an external memory. The external memory is one example of a second memory (a memory at a speed lower than that of the first memory). The high speed/low speed of the memory depend on at least one of whether the memory is in the FPGA 160 or not and the type of the memory. The server 100 is one example of the calculator. The server 100 includes an I/F 180, a memory 120, and a CPU 110 coupled to the I/F 180 and the memory 120. The I/F 180 is one example of an interface unit. The memory 120 is one example of the storage resource. The CPU 110 is one example of the processor unit.

As described above, the plurality of respective SSDs 140 are one example of the storage medium. Another kind of storage medium, for example, an HDD (Hard Disk Drive) can be employed instead of at least one of the plurality of SSDs 140. The plurality of SSDs 140 store the DB tables.

The DB processing board 150 is one kind of the accelerator. As described above, the DB processing board 150 includes the FPGA 160 and the DRAM 170. The FPGA 160 can also be referred to as one example of the accelerator. The FPGA 160 includes the SRAM 164. For the FPGA 160, the SRAM 164 in the FPGA 160 has a speed higher than that of the DRAM 170, which is outside the FPGA 160. The FPGA 160 executes local processing (processing including data reading, grouping, and local aggregation processing) in response to a local command, which is described later, from a DBMS 130. Specifically, the FPGA 160 includes a data reading unit 161, a control unit 162, a grouping processing unit 163, and a local aggregation processing unit 165. The control unit 162 responds to the local command from the DBMS (Database management system) 130, instructs the respective data reading unit 161, grouping processing unit 163, and local aggregation processing unit 165 to execute the processing, and returns the execution result of the local command to the DBMS 130. The data reading unit 161 reads the data from the SSD 140 and stores the read data in the SRAM 164. The grouping processing unit 163 groups the read data (the data in the SRAM 164). The local aggregation processing unit 165 executes the local aggregation processing, processing to aggregate the grouped data (the data in the SRAM 164). Here, while the SRAM 164 stores all data read by the data reading unit 161, the data grouped by the grouping processing unit 163, and the data aggregated by the local aggregation processing unit 165, when a free space in the SRAM 164 becomes insufficient, the DRAM 170 stores the data.

The memory 120 stores the DBMS 130 as one example of a computer program executed by the CPU 110. The DBMS 130 includes a query executing unit 131, a build processing unit 132, a grouping column identifying unit 133, a local command creating unit 134, and a global aggregation processing unit 135 and manages a DB management table 136 and a segment management table 137. The query executing unit 131 receives a query from a query source (not illustrated), appropriately issues an instruction to another processing unit 132, 133, 134, or 135, and returns the result of the query to the query source. The query source may be an application program (not illustrated) executed by the server 100 or may be a client (not illustrated) coupled to the server 100. The build processing unit 132 executes the build processing in the hash join processing. The grouping column identifying unit 133 identifies a grouping column. The local command creating unit 134 creates the local command (one example of the command), which is a command to the DB processing board 150 (the FPGA 160) and a command to execute the local processing. The global aggregation processing unit 135 executes global aggregation processing as processing that aggregates the aggregation results from the plurality of DB processing boards 150 using a hash table (a build table). The probe processing includes both processing of the local processing and the global aggregation processing. The DB management table 136 holds information on the DB tables. The segment management table 137 holds information on segments of the DB tables.

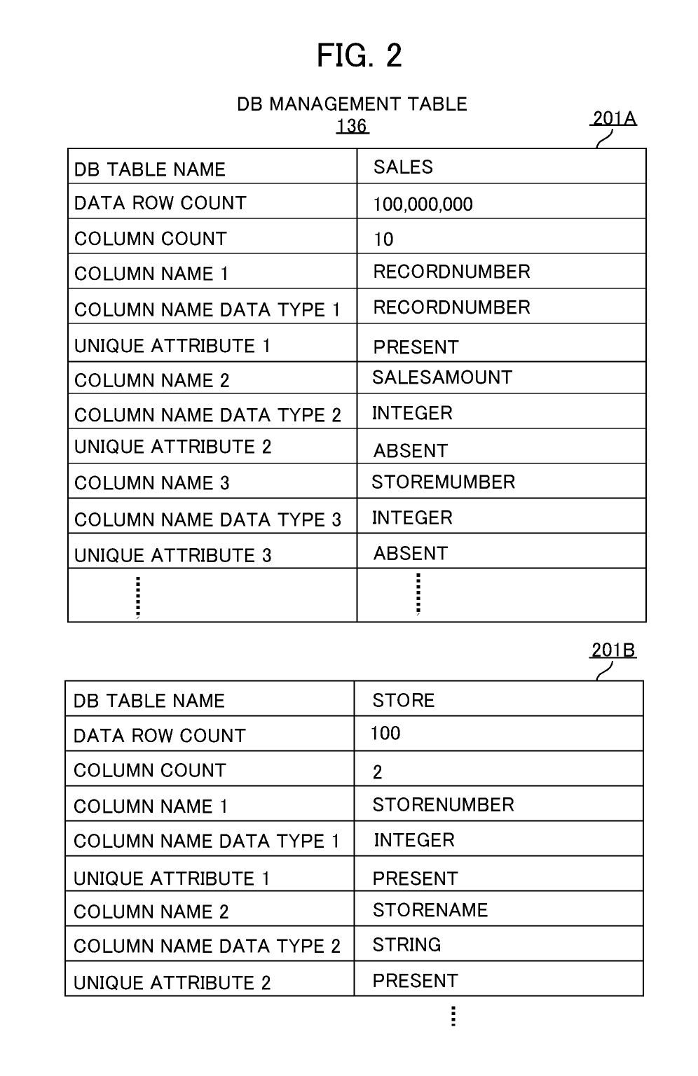

FIG. 2 illustrates the configuration of the DB management table 136.

The DB management table 136 includes a sub table 201 with respect to each DB table. The sub table 201 holds information indicative of a DB table name, a data row count (a record count), and a column count. The sub table 201 holds information indicative of a column name, a column data type, and a unique attribute with respect to each column. The “unique attribute” means whether a plurality of different values are present or not at any of columns other than the corresponding column as values corresponding to an identical value (data) at the corresponding column. For example, the unique attribute being “Present” in the DB table “Store” means that a plurality of different values are absent at any of columns (the columns in the DB table “Store”) other than the corresponding column as the values corresponding to the identical value at the corresponding column. For example, the unique attribute being “Absent” in the DB table “Sales” means that a plurality of different values are present at any of columns (the columns in the DB table “Sales”) other than the corresponding column as the values corresponding to the identical value at the corresponding column.

A sub table 201A is a table corresponding to a Fact table (the DB table name “Sales”). Meanwhile, a sub table 201B is a table corresponding to a Dimension table (the DB table name “Store”) associated with the Fact table (the DB table name “Sales”).

The DB management table 136 may be present with respect to each star schema or the two or more sub tables 201 may be held with respect to each star schema. Additionally, the sub table 201A, which corresponds to the Fact table, may hold a pointer to the sub table 201B, which corresponds to the Dimension table associated with the Fact table, or the sub table 201B, which corresponds to the Dimension table, may hold a pointer to the sub table 201A, which corresponds to the Fact table with which the Dimension table is associated.

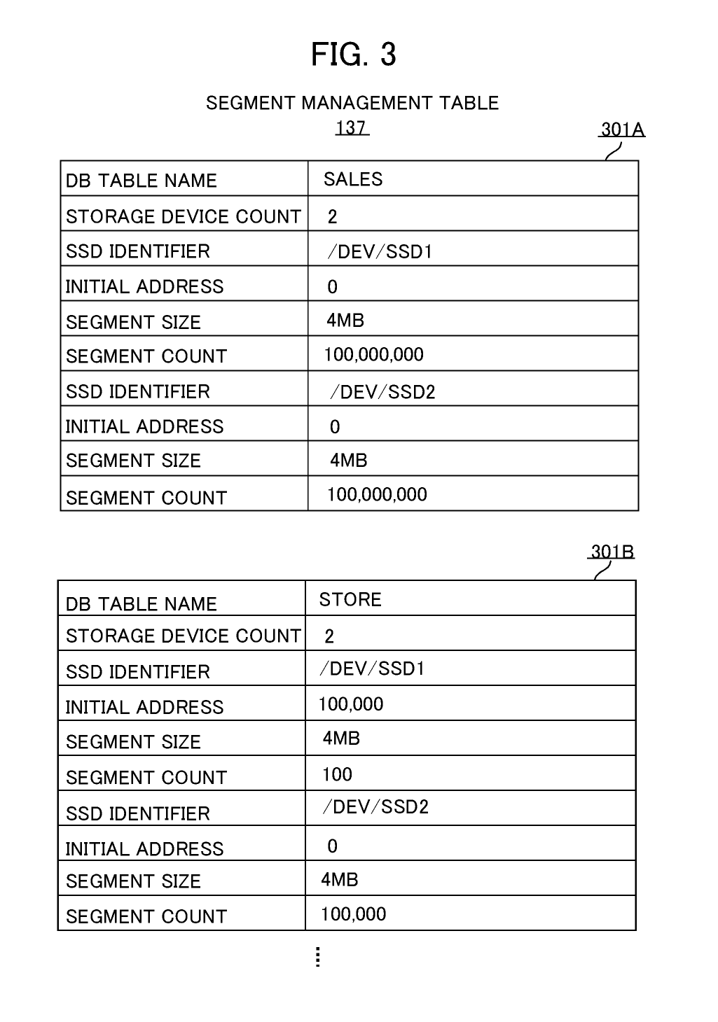

FIG. 3 illustrates the configuration of the segment management table 137.

The segment management table 137 includes a sub table 301 with respect to each DB table. The sub table 301 holds information indicative of a DB table name and a storage device count (the count of the storage devices (the SSDs 140) storing the corresponding DB tables). The sub table 301 holds information indicative of an SSD identifier (an identifier of the SSD as the storage device, an initial address (an initial address of an area storing the corresponding DB table), a segment size (a size of the segment), and a segment count (the count of segments constituting the DB tables in the corresponding storage devices) with respect to each storage device.

A sub table 301A is a table corresponding to a Fact table (the DB table name “Sales”). Meanwhile, a sub table 301B is a table corresponding to a Dimension table (the DB table name “Store”) associated with the Fact table (the DB table name “Sales”).

The segment management table 137 may be present with respect to each star schema or the two or more sub tables 301 may be held with respect to each star schema. Additionally, the sub table 301A, which corresponds to the Fact table, may hold a pointer to the sub table 301B, which corresponds to the Dimension table associated with the Fact table, or the sub table 301B, which corresponds to the Dimension table, may hold a pointer to the sub table 301A, which corresponds to the Fact table with which the Dimension table is associated.

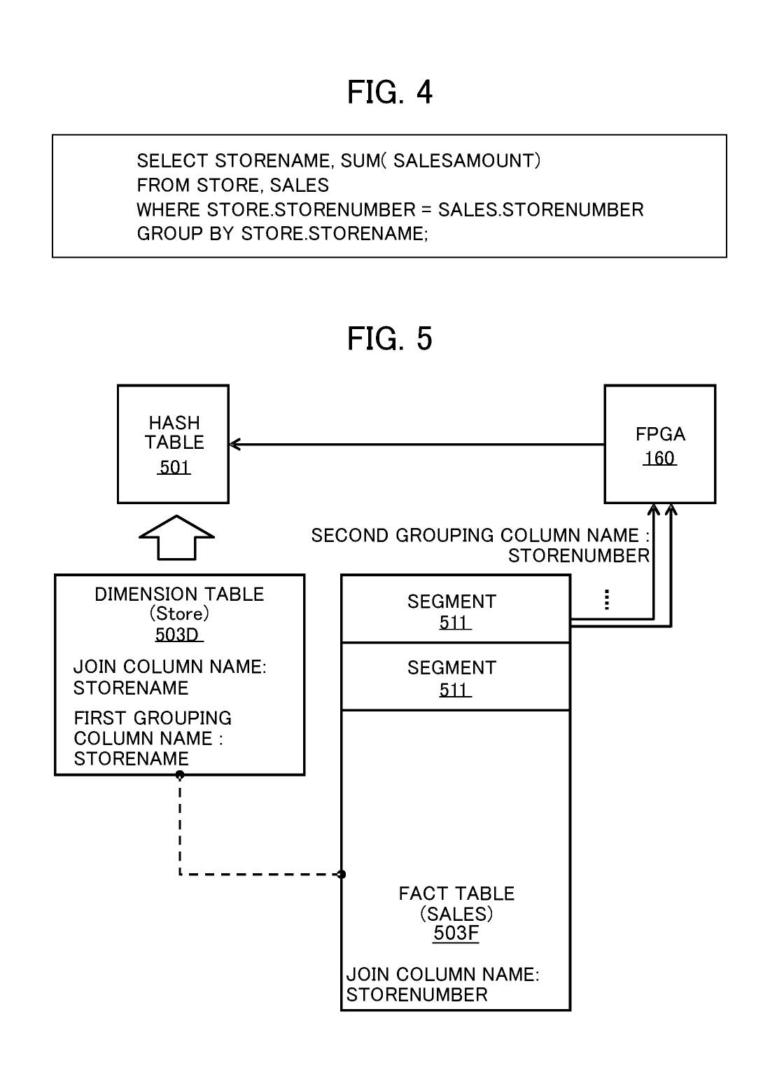

FIG. 4 illustrates one example of the query.

The query is, for example, an SQL. Specifically, for example, the query is a SELECT statement in the SQL. Specifically, for example, in the query, a SELECT clause (the column “StoreName”, an aggregation method “SUM(SalesAmount)”), a FROM clause (the DB tables “Store” and “Sales”), a WHERE clause (a condition that the value at the column “StoreNumber” in the DB table “Store” matches the value at the column “StoreNumber” in the DB table “Sales”), and a GROUP BY clause (grouping by the column “StoreName” in the DB table “Store”) are designated. In the following description, the column designated by the GROUP BY clause is referred to as “first grouping column.” The column designated by the WHERE clause is referred to as “join column.”

FIG. 5 is a schematic diagram of an outline of the join processing according to the embodiment.

For example, the star schema that includes the Fact table and a large number of (one or more) Dimension tables associated with the Fact table is used. Generally, the Fact table is a table managing purchase logs or similar logs and its data volume is large. Meanwhile, the Dimension table is a table storing a branch name, a product name, or similar information and its data volume is small.

Assume that the hash join processing responded to the query is the join processing of a Fact table 503F and a Dimension table 503D. The Dimension table 503D is one example of a first DB table. The Fact table 503F is one example of a second DB table.

The hash join processing generally includes the following two processes.
Build processing: processing that creates a hash table of a smaller table (typically the Dimension table) among the two DB tables. The hash table may be referred to as a build table.
Probe processing: processing that calculates a hash value of a value in a larger table (typically the Fact table) among the two DB tables and executes match determination between the calculated hash value and the hash value in the hash table. The larger table may be referred to as a probe table.

Among these two processes, the probe processing generally has a larger record count and a higher load. The probe processing occupies the largest proportion in the processing time of the join processing.

In this embodiment, the FPGA 160 in the DB processing board 150 executes the grouping processing and the aggregation processing for the high-speed hash join processing.

Specifically, the server 100 executes the build processing (processing that creates a hash table 501 of the Dimension table 503D), the FPGA 160 executes a part of the probe processing (for example, the grouping processing and the local aggregation processing), and the server 100 executes the remaining probe processing (for example, the global aggregation processing).

The FPGA 160 executes the grouping processing and the local aggregation processing with respect to each segment 511 in the Fact table 503F (one example of the probe table). Specifically, the FPGA 160 executes (a) reading of the data in the Fact table, (b) grouping of the read data (the grouping processing), (c) aggregation of the grouped data (the local aggregation processing), and (d) return of the aggregation result to the server 100 with respect to each segment 511 in the Fact table. The processing including (a) to (d) with respect to each segment 511 is the local processing.

Since (a) to (d) are executed with respect to each segment 511, the high speed processing by the FPGA 160 can be expected. For example, the FPGA 160 uses the SRAM 164 for execution of (a) to (d) with respect to each segment 511. That is, the SRAM 164 stores all of the data read in (a), the data grouped in (b), and the data aggregated in (c). However, in case of the insufficient free space in the SRAM 164, the DRAM 170 stores the data. The size of the segment 511 is the segment size as recorded in the segment management table 137, and the size is a size where a size of a memory area used for (a) to (d) becomes less than the size of the SRAM 164. This allows avoiding the use of the DRAM 170 for the local processing. Therefore, the local processing is executed at a high speed.

According to the query illustrated in FIG. 4 as the example, while the first grouping column (the column designated by the GROUP BY clause) is “StoreName,” the join column (the column fitted to the condition for the match determination) as the column designated by the WHERE clause is “StoreNumber” (in the first place, the column “StoreNumber” is present in the Fact table “Sales” but the column “StoreName” is absent in this embodiment). In view of this, the grouping column (the grouping column designated by the local command) designated to the FPGA 160 by the server 100 needs to be the column “StoreNumber,” which is different from the first grouping column “StoreName.” In the following description, the grouping column designated by the local command is referred to as “second grouping column.” The FPGA 160 reads the data with respect to each segment 511, groups the read data by the second grouping column “StoreNumber,” executes the local aggregation processing, which is aggregation of the grouped data, and returns the aggregation results to the server 100. The server 100 collates the aggregation results from the plurality of FPGAs 160 with the hash tables 501.

The hash join processing according to the embodiment reduces the load of the probe processing on the server 100, resulting in the high speed join processing. Assume that, for example, the one segment 511 includes 64000 records. Further, assume that 100 different values are present as the StoreName values (the values at the columns “StoreName”) (that is, assume that 100 different Store names are present). In the case where the DB processing board 150 is used in the join processing, the load of the probe processing on the server 100 is reduced to 100/64000 0.16% compared with the case where the DB processing board 150 is not used.

The following describes details of a flow of the join processing according to the embodiment. Then, FIG. 2 to FIG. 5 are employed as the specific examples.

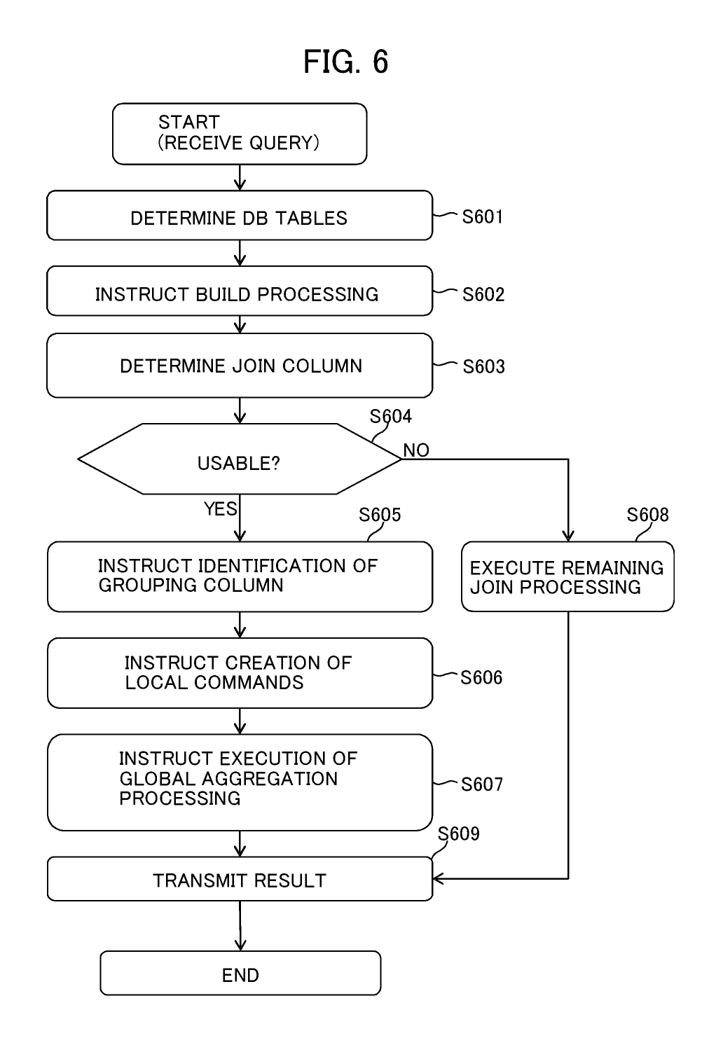

FIG. 6 illustrates a process flowchart by the query executing unit 131. This process flowchart is started when the query executing unit 131 receives the query from the query source.

At S601, the query executing unit 131 responds to the query and determines two DB tables as join targets in the join processing. Here, assume that the two DB tables are determined as the Fact table 503F and the Dimension table 503D.

At S602, the query executing unit 131 instructs the build processing unit 132 to execute the build processing. In accordance with the instruction, the build processing unit 132 executes the build processing, that is, the build processing unit 132 creates a hash table of a DB table with the smaller data row count (record count) among the two DB tables 503F and 503D determined at S601. “DB table with the smaller data row count (record count)” is typically the Dimension table 503D. Here, assume that the hash table 501 of the Dimension table 503D is created. The Dimension table 503D is one example of the first DB table. For example, the location (for example, the address of the memory 120) of the created hash table 501 is returned to the query executing unit 131 as the response to the instruction.

At S603, the query executing unit 131 determines the join column of the two DB tables 503F and 503D. Here, assume that the join column is the column “StoreNumber.”

At S604, the query executing unit 131 determines whether the DB processing board 150 is usable or not.

When the result of the determination of S604 is false (S604: No), S608 is executed. At S608, the query executing unit 131 executes the remaining join processing (that is, processing including the entire probe processing).

Meanwhile, in the case where the result of the determination of S604 is true (S604: Yes), S605 to S607 are executed.

At S605, the query executing unit 131 instructs the grouping column identifying unit 133 to identify the grouping column. In accordance with the instruction, the grouping column identifying unit 133 identifies a second grouping column name, that is, the grouping column name (“StoreNumber”) of the Fact table 503F as the probe table based on the first grouping column name (“StoreName”). As the response to the instruction, the identified second grouping column name is returned to the query executing unit 131.

At S606, the query executing unit 131 instructs the local command creating unit 134 to create the local commands. In accordance with the instruction, the local command creating unit 134 creates the local commands with respect to each of the one or more DB processing boards 150, which read the data from the one or more SSDs storing the Fact tables 503F, and transmits the created local commands. The FPGA 160 that has received the local commands executes the local processing in response to the local commands. The FPGA 160 returns the aggregation results as the results of the local aggregation processing to the DBMS 130 with respect to each segment in the local processing.

At S607, the query executing unit 131 instructs the global aggregation processing unit 135 to execute the global aggregation processing. In accordance with the instruction, the global aggregation processing unit 135 executes the global aggregation processing. That is, the global aggregation processing unit 135 aggregates the aggregation results from the one or more DB processing boards 150 as the transmission destinations of the one or more local commands.

At S609, the query executing unit 131 returns the result of the join processing (the result of the query) to the query source. The result returned here is the result of S607 or S608.

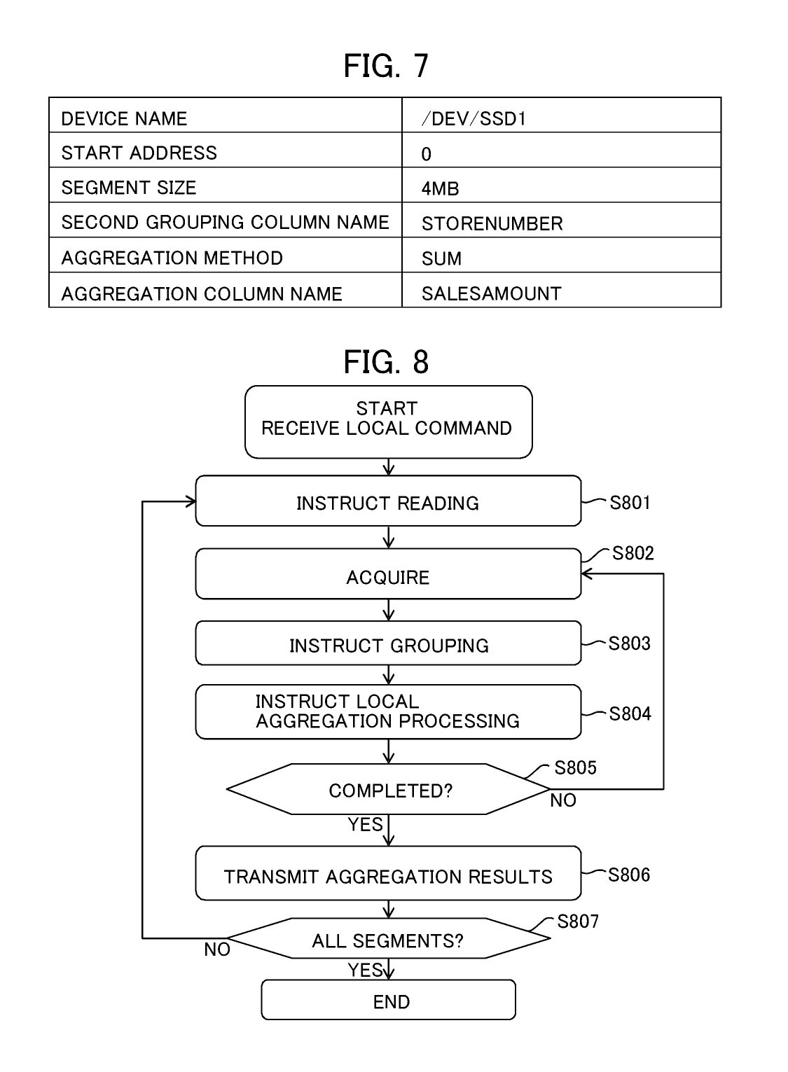

FIG. 7 illustrates one example of the local command.

For example, a device name, a starting address, a segment size, a second grouping column name, an aggregation method, and an aggregation column name are designated in the local command.

The device name is a device name of the read source SSD. The read source SSD is the SSD 140 in the storage package 198 including the DB processing board 150 as the transmission destination of the local command. The start address is the address (the logical address) of the SSD and an initial address of an area storing the Fact table. The segment size is the size of the segment 511. The second grouping column name is the column name of the above-described second grouping column. The aggregation method is an aggregation method (typically the identical aggregation method) in accordance with the aggregation method designated by the query. Specifically, the local command creating unit 134 identifies the aggregation method (SUM) from the SELECT clause and the identified aggregation method is designated by the local command. The aggregation column name is a column name of a column holding the aggregated value (the column value).

FIG. 8 illustrates a process flowchart of the control unit 162 in the FPGA 160. This process flowchart is started when the control unit 162 receives the local command from the DBMS 130. While the one local command is issued to the DB processing board 150 in one join processing, the local command may be issued with respect to each segment.

At S801, the control unit 162 instructs the data reading unit 161 to read the data. In accordance with this instruction, the data reading unit 161 reads the data by the amount of segment size starting from the start address. The segment size is the segment size designated by the local command. The SRAM 164 stores the read data.

At S802, the control unit 162 acquires the data by an amount of one record from the read data (the data by the amount of segment size).

At S803, the control unit 162 groups the data acquired at S802 by the second grouping column. The SRAM 164 stores the data acquired at S802 and the data is grouped at S803. The second grouping column is the column with the second grouping column name designated by the local command.

At S804, the control unit 162 instructs the local aggregation processing unit 165 to execute the local aggregation processing. In accordance with the instruction, the local aggregation processing unit 165 executes the local aggregation processing. Specifically, the local aggregation processing unit 165 aggregates aggregation column values in the grouped data (records) in accordance with the aggregation method. The “aggregation column values” are values at the columns with the aggregation column name. The aggregation column name and the aggregation method are designated by the local command. According to the example of FIG. 7, a sum (SUM) of the values at the aggregation columns “SalesAmount” is calculated.

At S805, the control unit 162 determines whether all record data has been acquired from the data by the amount of segment size read at S802 or not. When the determination result at S805 is false (S805: No), S802 is executed on unacquired records. When the determination result at S805 is true (S805: Yes), S806 is executed.

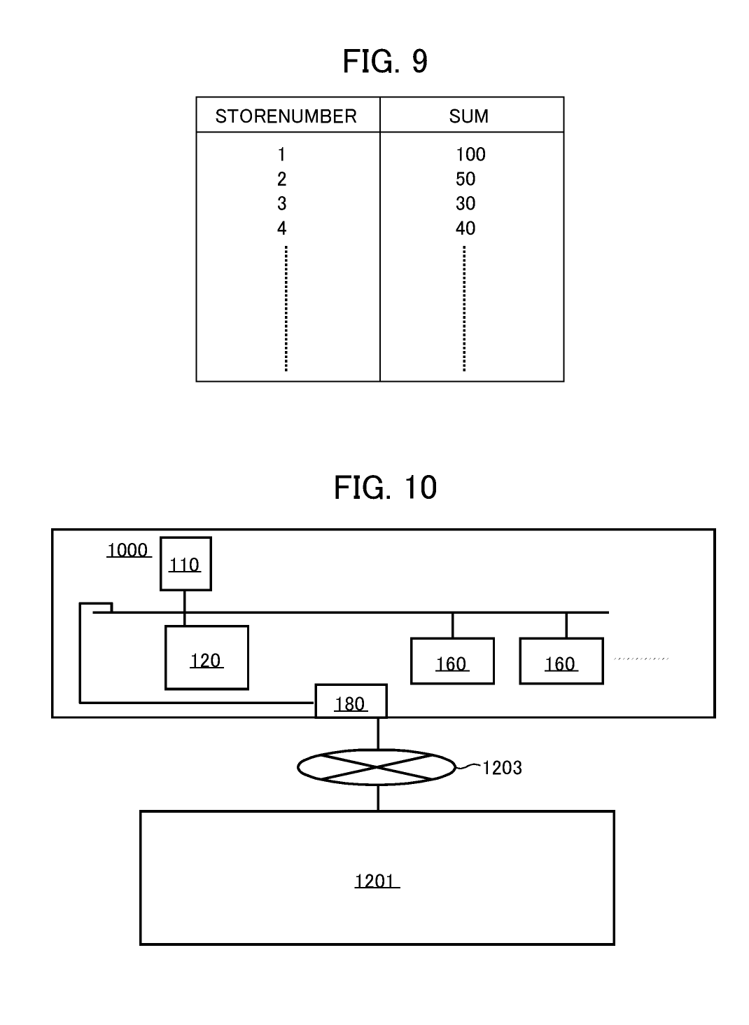

At S806, the control unit 162 returns the aggregation results of the data by the amount of segment size to the DBMS 130. FIG. 9 illustrates one example of the aggregation results. That is, the aggregation results hold the column values in the second grouping columns “StoreNumber,” and hold a sum (SUM) of the column values in the aggregation columns “SalesAmount” with respect to each column value.

At S807, the control unit 162 determines whether all segments have been read or not. When the determination result at S805 is false (S807: No), S801 is executed on segments that have not been read yet. When the determination result at S807 is true (S807: Yes), processing in accordance with the local command, namely, the local processing is terminated.

As described above, the FPGA 160 executes (a) reading of the data in the Fact table, (b) grouping of the read data by the second grouping column name designated by the received local command, (c) aggregation of the grouped data in accordance with the aggregation method and the aggregation column designated by the local command, and (d) return of the aggregation result (at least a part of the execution results of the local processing) with respect to each segment in the Fact table (one example of the probe table).

The global aggregation processing unit 135 in the DBMS 130 aggregates the aggregation results from the plurality of FPGAs using the hash table. The aggregation is executed as follows with an example of FIG. 9. That is, the global aggregation processing unit 135 acquires one StoreNumber value (for example, “1”) from the aggregation results, calculates the hash value of the StoreNumber value, and determines whether the hash value identical to the calculated hash value is present in the hash table or not. When the determination is true, the global aggregation processing unit 135 adds the SUM value corresponding to the StoreNumber value in the aggregation result to the aggregated values (the summed value) of the StoreNumber values up to the present to calculate the latest aggregated value corresponding to the StoreNumber value.

The aggregated value with respect to each StoreNumber value is calculated as the result of such global aggregation processing. The query executing unit 131 replaces each StoreNumber value with a StoreName value (the value at the column “StoreName”) corresponding to the StoreNumber value. The query executing unit 131 returns a list of the StoreName values and the aggregated values (the sum of the SalesAmount values) to the query source as the result of the query.

In the above-described description, the StoreNumber value is one example of the second grouping column value. The StoreName value is one example of the first grouping column value. Although the second grouping column is different from the first grouping column in the above-described example, the second grouping column is possibly identical to the first grouping column. The SalesAmount value is one example of the aggregation column value.

### Second Embodiment

The following describes the second embodiment. The following mainly describes differences from the first embodiment, and descriptions common to those of the first embodiment are omitted or simplified.

FIG. 10 illustrates a configuration of a computer system according to the second embodiment.

A calculator 1000 that incorporates the FPGA 160 is employed. The FPGA 160 in the calculator 1000 reads data from an external storage 1201 via a network 1203. The external storage 1201 is one example of a storage medium. The external storage 1201 may be a so-called disk array device that has, for example, a RAID (Redundant Array of Independent (or Inexpensive) Disks) group and provides a logic volume.

The FPGA 160 can read data from the external storage 1201 with respect to each segment.

### Third Embodiment

The following describes the third embodiment. The following mainly describes differences from the first embodiment and the second embodiment, and descriptions common to those of the first embodiment and the second embodiment are omitted or simplified.

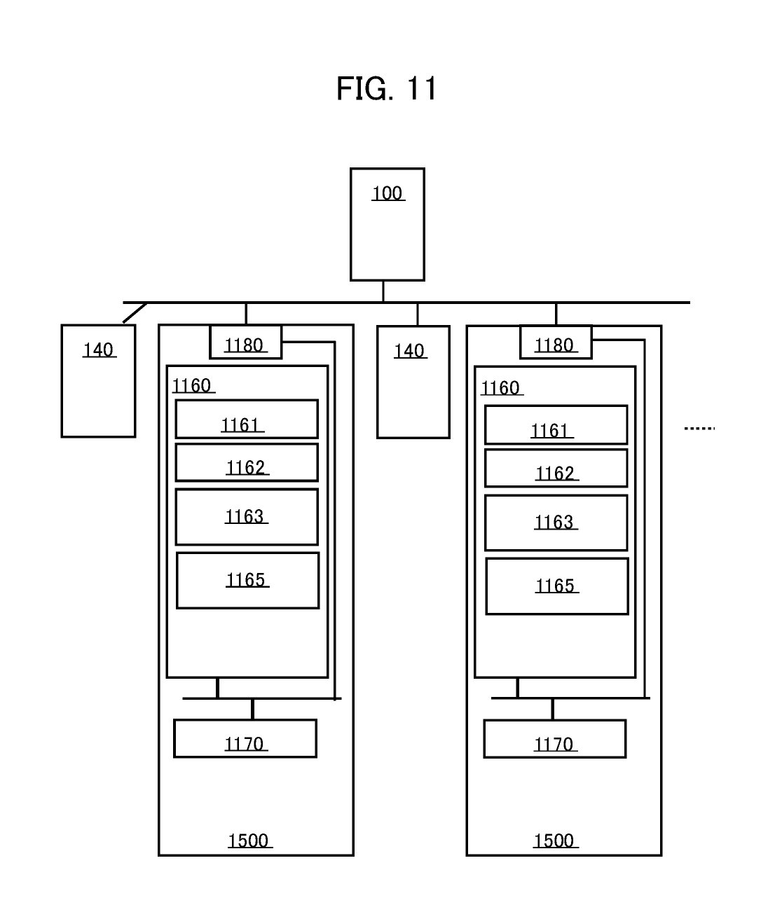

FIG. 11 illustrates a configuration of a computer system according to the third embodiment.

Instead of the DB processing board 150 (and the storage package 198 including the DB processing board 150), an accelerator node 1500 is employed. The accelerator node 1500 is one example of an accelerator. As the accelerator, the DB processing board 150 and the accelerator node 1500 may be mixed in the computer system.

The accelerator node 1500 may be a calculator and includes an I/F 1180, a memory 1160, and a CPU 1170 coupled to the I/F 1180 and the memory 1160. The I/F 1180 is an interface device for communications with the server 100 and the SSD 140. The memory 1160 stores a data reading unit 1161, a control unit 1162, a grouping processing unit 1163, and a local aggregation processing unit 1165 as programs. The CPU executes these processing units (the programs) 1161, 1162, 1163, and 1165.

While some embodiments have been described above, the present invention is not limited to the above-described embodiments and is applicable to other various aspects. For example, instead of the FPGA 160, a hardware circuit of another type, for example, a PLD (Programmable Logic Device) other than the FPGA 160 may be employed, and an ASIC (Application Specific Integrated Circuit) may be employed.

### LIST OF REFERENCE SIGNS

100 server

1. A computer system comprising:
an interface unit as one or more interfaces coupled to one or more accelerators, the one or more accelerators being configured to read data from one or more storage media, the one or more storage media storing a database including a plurality of database tables (DB tables); and
a processor unit as one or more processors coupled to the interface unit,
wherein the processor unit is configured to:
execute first processing among join processing of a first DB table and a second DB table designated by a query among the plurality of DB tables in response to the query, the join processing including the first processing and second processing sequentially executed;
transmit one or more commands for execution of a part of processing of the second processing among the join processing to the one or more accelerators;
execute remaining processing of the second processing based on an execution result received from the one or more accelerators in response to the one or more commands; and
return a result of the query based on an execution result of the remaining processing, and
the one or more accelerators are each configured to:
receive a command from the processor unit;
execute local processing as processing in accordance with the received command among the part of processing; and
return an execution result of the local processing.

2. The computer system according to claim 1,
wherein the join processing is hash join processing,
the first processing is processing including build processing, the build processing being processing including creation of a hash table of the designated first DB table, and
the second processing is processing including probe processing, the probe processing being processing including match determination between a hash value of a value in the designated second DB table and a hash value in the hash table.

3. The computer system according to claim 2,
wherein in the query,
an aggregation method; and
a first grouping column name are designated, in each of the one or more commands,
a second grouping column name as a column name in the second DB table, the second grouping column name being a column name corresponding to the first grouping column name designated by the query; and
an aggregation method in accordance with the aggregation method designated by the query are designated,
in the respective one or more accelerators, the local processing includes:
(a) reading of data in the second DB table from a read source among the one or more storage media;
(b) grouping of the read data by the second grouping column name designated by the received command;
(c) aggregating the grouped data in accordance with the aggregation method designated by the received command; and
(d) returning an aggregation result as at least a part of an execution result of the local processing, and
the remaining processing is processing including global aggregation processing, the global aggregation processing being processing to aggregate the aggregation result from the one or more accelerators using the hash table.

4. The computer system according to claim 3,
wherein the local processing executes (a) to (d) with respect to each segment in the second DB table.

5. The computer system according to claim 4,
wherein at least one of the one or more accelerators is a hardware circuit,
the hardware circuit includes:
a first memory; and
a second memory at a speed lower than a speed of the first memory,
the hardware circuit is configured to execute (a) to (d) with respect to each segment using the first memory,
when a free space in the first memory is insufficient, the hardware circuit uses the second memory, and
a segment size is a size such that a size of a memory area used for (a) to (d) becomes less than a size of the first memory.

6. The computer system according to claim 5,
wherein the hardware circuit is a circuit including an FPGA (Field-Programmable Gate Array) and an external memory, the FPGA (Field-Programmable Gate Array) including an internal memory,
the internal memory is the first memory, and
the external memory is the second memory.

7. The computer system according to claim 2,
wherein the second DB table is a Fact table, and
the first DB table is a Dimension table associated with the Fact table.

8. The computer system according to claim 1,
wherein the processor unit is configured to:
determine whether the one or more accelerators are usable or not,
transmit the one or more commands for execution of the part of processing to the one or more accelerators when a result of the determination is affirmative, and
execute the join processing without use of the one or more accelerators when the result of the determination is negative.

9. The computer system according to claim 8,
wherein whether the use of the one or more accelerators is allowed or not is set via a user interface,
when the use of the one or more accelerators is allowed, the result of the determination is affirmative, and
when the use of the one or more accelerators is inhibited, the result of the determination is negative.

10. The computer system according to claim 8,
wherein the join processing is hash join processing,
the first processing is processing including build processing, the build processing being processing including creation of a hash table of the designated first DB table,
the second processing is processing including probe processing, the probe processing being processing including match determination between a hash value of a value in the designated second DB table and a hash value in the hash table,
in the query, an aggregation method and a first grouping column name are designated,
in each of the one or more commands,
a second grouping column name as a column name in the second DB table, the second grouping column name being a column name corresponding to the first grouping column name designated by the query; and
an aggregation method in accordance with the aggregation method designated by the query are designated,
when a plurality of different values are absent at any of columns other than the first grouping column as values corresponding to an identical value at the first grouping column in the first DB table, the result of the determination is affirmative, and
when the plurality of different values are present at any of the columns other than the first grouping column as the values corresponding to the identical value at the first grouping column in the first DB table, the result of the determination is negative.

11. The computer system according to claim 1, comprising:
a calculator that includes the interface unit and the processor unit; and
the one or more accelerators coupled to the calculator.

12. The computer system according to claim 11, further comprising one or more storage packages,
wherein the one or more storage packages each include:
at least one storage medium; and
at least one accelerator configured to read data from the at least one storage medium.

13. The computer system according to claim 1, comprising a calculator that includes the interface unit, the processor unit, and at least one accelerator among the one or more accelerators.

14. A database management method comprising:
executing first processing among join processing in response to a query, the join processing including the first processing and second processing sequentially executed;
transmitting one or more commands for execution of a part of processing of the second processing among the join processing to one or more accelerators, the one or more accelerators being configured to read data from one or more storage media storing a database including a plurality of database tables (DB tables);
receiving execution results of local processing from the respective one or more accelerators, the local processing being processing in accordance with the received command among the part of processing in the respective one or more accelerators;
executing remaining processing of the second processing based on execution results from the respective one or more accelerators; and
returning a result of the query based on an execution result of the remaining processing.

15. A calculator-readable recording medium that records a computer program to cause the calculator to:
execute first processing among join processing in response to a query, the join processing including the first processing and second processing sequentially executed;
transmit one or more commands for execution of a part of processing of the second processing among the join processing to one or more accelerators, the one or more accelerators being configured to read data from one or more storage media storing a database including a plurality of database tables (DB tables);
receive execution results of local processing from the respective one or more accelerators, the local processing being processing in accordance with the received command among the part of processing in the respective one or more accelerators;
execute remaining processing of the second processing based on execution results from the respective one or more accelerators; and
return a result of the query based on an execution result of the remaining processing.
